(19) United States
(12) Patent Application Publication
(10) Pub. No.: US 2021/0011920 A1
(43) Pub. Date: Jan. 14, 2021

(54) ARCHITECTURE FOR DATA ANALYSIS OF GEOGRAPHIC DATA AND ASSOCIATED CONTEXT DATA

(71) Applicant: SparkCognition, Inc., Austin, TX (US)

(72) Inventors: Sridhar Sudarsan, Austin, TX (US); Syed Mohammad Amir Husain, Georgetown, TX (US); Milton Lopez, Round Rock, TX (US)

(21) Appl. No.: 16/848,552

(22) Filed: Apr. 14, 2020

Related U.S. Application Data
(60) Provisional application No. 62/819,008, filed on Mar. 15, 2019.

(51) Int. Cl. G06F 16/2457; G06F 16/29; G06F 16/28; G06F 16/242; G06N 20/00

(52) U.S. Cl. CPC G06F 16/24575; G06F 16/29; G06N 20/00; G06F 16/243; G06F 16/28

(57) ABSTRACT

An architecture for data analysis of geographic data and associated context data. The data analysis of the geographic data and the associated context data includes receiving a query and determining a data model to output information requested by the query. The data analysis of the geographic data and the associated context data also includes accessing the geographic data and the associated context data from a data repository, providing the geographic data and the associated context data as input to the data model, and generating output including the information in response to the query.

### CROSS-REFERENCE TO RELATED APPLICATION

The present application claims priority from U.S. Provisional Application No. 62/819,008 filed Mar. 15, 2019, entitled “ARCHITECTURE FOR DATA ANALYSIS OF GEOGRAPHIC DATA AND ASSOCIATED CONTEXT DATA,” which is incorporated by reference herein in its entirety.

### BACKGROUND

The last half century has seen a dramatic increase in the use of miniaturized and/or portable computing devices, many of which include a variety of sensors as well as electronic communication devices. Improvements in communications technologies and data storage technologies have accompanied this increased use of miniaturized and/or portable computing devices, leading to the availability of many large repositories of data captured by sensors of these devices.

Additionally, there has been a push for government entities, commercial entities, and individuals to share data electronically. For example, governments, companies, and individuals often share information via social media platforms, public calendars, and other electronic documents. As another example, data aggregators collect information about consumer habits, demographics, etc. from social media posts, computer use, and many other sources. Accordingly, large repositories of such data are also available. As yet another example, some companies share data as part of their business model. To illustrate, electronics maps, weather data, and many other types of data are shared by content generators to attract users for advertising revenue or for other reasons.

Some industries use subsets of these data sets for very specific purposes. For example, certain navigation applications use electronic maps in conjunction with user reports of traffic conditions to prepare route recommendations. While the benefits derived from such uses of the available data can be very helpful, they are also quite limited. To illustrate, in the example above, only the specific data needed to generate a route recommendation is collected, and the navigation application and supporting backend processes are focused on providing one type of result (i.e., the routing recommendation) with one specific data set.

### SUMMARY

The present disclosure describes an architecture for data analysis of geographic data and associated context data. The architecture provides an interface to one or more data repositories and is able to access the data repositories (individually or collectively) to perform data analysis. The interface includes a plurality of analysis applications, and the specific analysis application(s) used to generate a response to a query is selected in response to the query. For example, the query is analyzed to map the query to a particular analysis application or a set of analysis applications. If no available analysis application is configured to perform the analysis requested, an automated model building process is initiated to generate a machine-learning data model to perform the requested analysis. Thus, the specific analysis performed and the specific application(s) used to perform the analysis are selected based on the specific query. For some queries, this can even include automatically generating a machine-learning data model to perform particular analyses.

As an example, a user can request, via a query, that a predicted value be generated based on a particular data set. In this example, if no pre-existing data model is available to generate the predicted value based on the particular data set, the automated model building process is initiated to generate a new machine-learning data model to predict the value. The new machine-learning data model is then used to generate the predicted value, and the predicted value is returned in response to the query. The particular data set to be used can be specified in the query, can be automatically selected based on user access privileges, or can be unspecified. If the particular data set to be used is unspecified, the automated model building process can automatically select the particular data set from among a set of available data.

In addition to predicting values as in the example above, the automated model building process can generate machine-learning data models to generate optimization recommendations, to categorize data (e.g., to label anomalies or patterns), etc. Other analysis applications in the disclosed architecture can use heuristic operations (e.g., pre-configured rules and data filters) to generate query responses, or pre-configured machine-learning data models.

In some implementations, a combination of analysis applications can be used to generate a query result. For example, a first analysis application can be used to generate first analysis data that is used as input to another analysis application or to the automated model building application to generate second analysis data as a response to the query. To illustrate, a particular user can provide a query for an unusual route optimization, such as “What is the shortest route from my house to the mall that avoids driving past yellow fire hydrants?” To respond to this query, a first analysis application can generate first analysis data, such as fire hydrant location data with tags indicating fire hydrant locations associated with yellow fire hydrants. A second analysis application can use the yellow fire hydrant locations as negative waypoints (points to be avoided) in a route optimization operation to generate the second analysis data as a response to the query. In this example, both the first and second analysis applications can use structured or pre-configured data models; however, in other examples, one or both of these data models can be generated automatically in response to the query.

The data repository or data repositories that are accessible via the disclosed architecture correspond to (e.g., include data associated with) a particular geographic region. For example, a particular instance of the disclosed architecture can be associated with a geographically bounded region, such as a country, a state, a county, a city, a neighborhood, etc. A data repository associated with particular geographic region can include geographic data (e.g., data about the geographic region itself), such as maps, satellite images, photographs, text descriptions, or other information descriptive of the geographic region and features (e.g., structures and infrastructure) within the geographic region. The data repository (or another data repository associated with the particular geographic region) can include context data associated with the geographic region. Context data includes information descriptive of people, events, or conditions within or associated with the geographic region.

In some implementations, the content of the data repository or data repositories can be obtained from multiple distinct data sources. Sufficiently related data from distinct data sources can be merged. For example, two or more calendars of events can be merged into a single calendar database for the geographic region. In some implementations, data from a particular data source can be transformed before being merged with data from other data sources. The merger of two data sources can include any combination of extraction operations, transformation operations, and loading operations. The merger can also include data cleanup, such as omitting duplicate data, inserting or estimating missing data, identifying erroneous or suspect data, etc. The data cleanup operations can be performed using one or more machine learning processes. For example, when a new data source is added to a data repository or targeted for addition to the data repository (e.g., specified in a user input), the disclosed architecture can automatically generate a machine-learning classifier (e.g., an artificial neural network) to identify anomalies in data from the new data source. In this example, if the new data source includes time series data, the machine-learning classifier can be trained using historical data and subsequently used to check for errors in new data added to the new data source (e.g., time series data representing a future time period). If the new data source includes data other than time series data, the machine-learning classifier can use clustering or another unsupervised learning technique to identify data anomalies.

In a particular implementation, the disclosed architecture is used to support a software-as-a-service (SaaS) platform. In this implementation, the software-as-a-service platform enables customers (e.g., application builders) to develop custom application programming interfaces (APIs) to access specific data, data repositories, analysis application, or machine learning data models. These custom applications can be provided to users to improve or simplify the users' ability to analysis results. For example, custom applications that use the geographic data and context data in new and unique ways can be generated using the disclosed architecture. Because the disclosed architecture merges data from many distinct data sources and enables automated generation and training of machine learning data models to perform new data analyses, the customers can save significant time and effort during development of a custom application.

### BRIEF DESCRIPTION OF THE DRAWINGS

FIG. 1 illustrates a particular implementation of a system that is operable to perform data analysis of geographic data and associated context data in accordance with one or more aspects disclosed herein;

FIG. 2 illustrate a first example of a user interface of a ride sharing application that uses the system of FIG. 1 to perform data analysis of geographic data and associated context data in accordance with one or more aspects disclosed herein;

FIG. 3 illustrate a second example of a user interface of the ride sharing application that uses the system of FIG. 1 to perform data analysis of geographic data and associated context data in accordance with one or more aspects disclosed herein;

FIG. 4 illustrate a third example of a user interface of the ride sharing application that uses the system of FIG. 1 to perform data analysis of geographic data and associated context data in accordance with one or more aspects disclosed herein;

FIG. 5 illustrate a fourth example of a user interface of a ride sharing application that uses the system of FIG. 1 to perform data analysis of geographic data and associated context data in accordance with one or more aspects disclosed herein;

FIG. 6 is a flowchart to illustrate a particular implementation of a method of data analysis of geographic data and associated context data in accordance with one or more aspects disclosed herein;

FIG. 7 illustrates a particular implementation of a system that is operable to adjust an architectural parameter of an automated model generation process based on characteristics of an input data set; and

FIG. 8 illustrates is a diagram to illustrate a particular implementation of a system that is operable to determine a topology of a neural network based on execution of a genetic algorithm.

### DETAILED DESCRIPTION

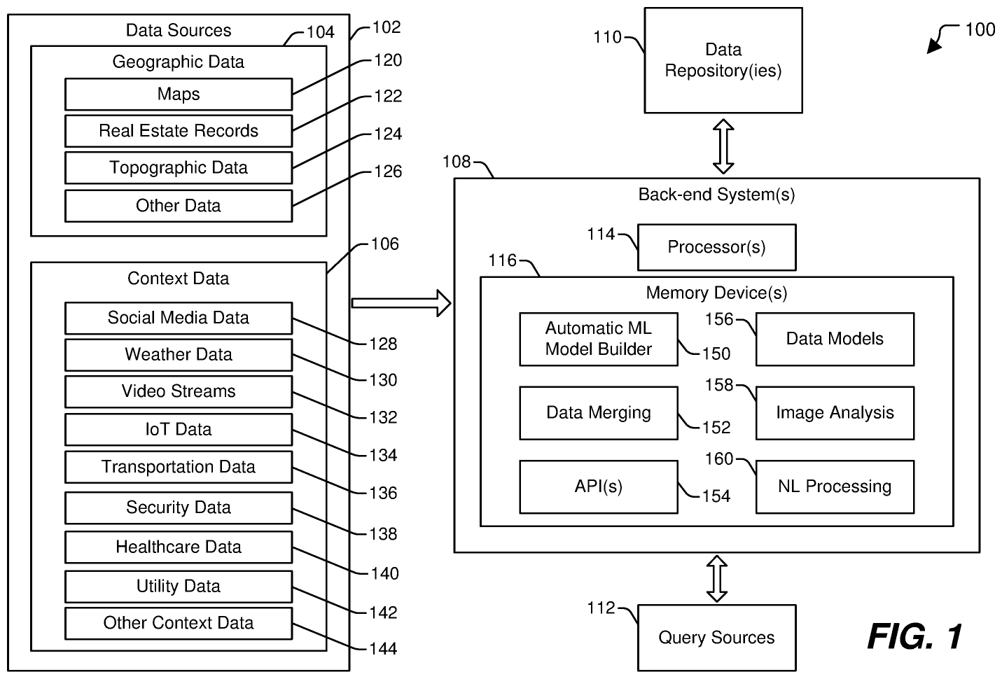

FIG. 1 illustrates a particular implementation of a system 100 that is operable to perform data analysis of geographic data and associated context data in accordance with one or more aspects disclosed herein. The system 100 includes a plurality of data sources 102, one or more back-end systems 108, one or more data repositories 110, and one or more query sources 112. The back-end systems 108 alone or in combination with the data repositories 110, the query sources 112, or both, include or correspond to an architecture for data analysis of geographic data and associated context data. In a particular implementation, the back-end systems 108 include one or more processors 114 and one or more memory devices 116. For example, the back-end systems 108 can include one or more server computer devices that includes instructions to perform the data analysis and other operations described herein.

The data repositories 110 include one or more memory devices storing data, such as one or more flat files, one or more relational databases, or other data structures. Although the data repositories 110 are illustrated as separate from the back-end systems 108, in some implementations, the data repositories 110 are integrated with the back-end systems 108.

The data sources 102 include any combination of electronic records representing geographic data 104 for a particular geographic region (e.g., a neighborhood, a city, a county, a state, etc.) and context data 106 for the particular geographic region. Examples of geographic data 104 illustrated in FIG. 1 include maps 120 (or map data), real estate records 122 (e.g., plats, property tax records, survey records, listing service records, etc.), topographic data 124 (e.g., contour maps), and other data 126. The other data 126 can include any information descriptive of the geographic region itself or infrastructure (e.g., persistent features) within the geographic region. To illustrate, the other data 126 can include information descriptive of geologic features (e.g., geologic survey data), information descriptive of named or designated locations, such as parks or preserves etc. The data sources 102 that store the geographic data 104 can include publicly-accessible data sources, such as government digital records databases or online map provider databases; can include private data sources, such as subscription map provider databases, custom-developed databases; or can include a combination of publicly-accessible and private data sources.

Examples of context data 106 associated with the particular geographic region illustrated in FIG. 1 include social media data 128, weather data 130, video streams 132, internet of things (IoT) device data 134, transportation data 136, security data 138, healthcare data 140, utility data 142, and other context data 144. Generally, the context data 106 can include any information that is descriptive of conditions, events, or other temporary circumstances within the geographic region. The context data 106 can be determined to be associated with the particular geographic region based on one or more of several factors. For example, some of the context data 106 can be determined to be associated with the particular geographic region based on location data or metadata associated with the context data 106. To illustrate, a social media post can include or be associated with global positioning system (GPS) location data (e.g., a geotag) indicting where a device that generated the social media post was located when the social media post was generated. As another example, a video stream 132 can include or be associated with location metadata. In such examples, the location data or metadata can be matched to the maps 120 to determine whether a location indicated by the location data or metadata is within the geographic region.

As another example, some of the context data 106 can include a reference to a location within the geographic region. To illustrate, a social media post can refer to a specific location (e.g., a park, a street, a restaurant, an address, etc.) within the geographic region. As another example, the transportation data 136, security data 138, the healthcare data 140, or the utility data 142, can include a document purporting to report on conditions associated with the geographic region. To illustrate, the healthcare data 140 can include a document that refers to care provided by a hospital that is within the geographic region.

As yet another example, some of the context data 106 can be determined to be associated with the geographic region based on a source of the data. To illustrate, context data 106 derived from a Metro section of local newspaper or from a Weather section of a local news station is considered to be associated with the geographic region based on the source from which the context data 106 was retrieved. As another illustrative example, the utility data 142 can include information retrieved from a local utility provider, such as a water, wastewater, refuse, cable television, or electrical provider. In this illustrative example, the information retrieved from a local utility provider is considered to be associated with the geographic region based on the source from which the context data 106 was retrieved.

The back-end systems 108 are configured to access the data sources 102 to retrieve the geographic data 104, the context data 106, or both. For example, the back-end systems 108 can include one or more bot applications, data scrapers, database engines, or other applications that are configured to periodically or occasionally access various ones of the data sources 102 and extract information.

The back-end systems 108 are also configured to generate or update the data repositories 110 using the information extracted from the data sources 102. For example, the back-end systems 108 in FIG. 1 include one or more data merging applications 152. The one or more data merging applications 152 are configured to perform extraction, transformation, and loading (ETL) operations to incorporate the geographic data 104 and the context data 106 obtained from the data sources 102 into data structures of the data repositories 110. The data merging applications 152 can also perform data manipulations to prepare the data obtained from the data sources 102 for future use. To illustrate, the data merging applications 152 can identify anomalies (e.g., using unsupervised processes, such as clustering, or using heuristic processes, such as pattern matching) in the data obtained from the data sources 102 and either tag anomalous data or omit the anomalous data from the data repositories 110. As another illustrative example, the data merging applications 152 can reconcile data representations from two or more of the data sources 102. For example, a first data source can store time series data using a first time index (15 minute intervals), and a second data source can store time series data using a different second time index (e.g., 5 second intervals). In this example, the data merging applications 152 can reconcile the data by converting the time series to a common time index, which can be the first time index, the second time index, or a different third time index.

As yet another illustrative example, the data merging applications 152 can estimate missing values. To illustrate, in time series data, if no value is indicated for a particular time interval, the data merging applications 152 can estimate the value by interpolating between values of adjacent time intervals.

In some implementations, the data merging applications 152 can also perform more complex data manipulations to merge data from the data sources 102 into the data repositories 110. To illustrate, the back-end systems 108 can include one or more natural language (NL) processing applications 160 or one or more image analysis applications 158 that the data merging applications 152 can use to pre-process the data. For example, images extracted from the data sources 102 can be processed using the image analysis applications 158 to identify particular features, such as a count or estimate a number of individuals present at particular location based on an image or video stream. As another example, text or documents from the data sources 102 can be analyzed using the NL processing applications 160 to identify events that are scheduled to occur in the geographic area.

The back-end systems 108 in FIG. 1 also include one or more applications to facilitate access to and analysis of data in the data repositories 110. For example, the back-end systems 108 include one or more application programming interfaces (APIs) 154 to enable access to the back-end systems 108 by various query sources 112, e.g., via a software-as-a-service (SaaS) model. The APIs 154 can be configured to receive structured or unstructured (e.g., natural language) queries from the query sources 112. In some implementations, the back-end systems 108 provide an architecture for accessing data in the data repositories 110 and for analyzing the data. The architecture enables application developers to generate custom applications to act as query sources 112. In such implementations, the APIs 154 enable the back-end systems 108 to appropriately parse and process queries from a variety of different query source applications. The architecture can support a large variety of different types of query source applications, enable new business or uses cases to be generated based on the data in the data repository. Several distinct uses case examples are described below as illustrative examples.

For some queries, the back-end systems 108 can simply retrieve and display requested data. However, the back-end systems 108 can also perform complex analyses of the data based on specific queries. To this end, the back-end systems 108 include one or more data models 156, which can include heuristic data models, such as data filtering models, as well as machine-learning models, such as neural networks, decision trees, support vector machines, etc. At least some of the data models 156 can be pre-configured (e.g., configured before a query for data output by the data model is received at the back-end systems 108).

In some implementations, the back-end systems 108 include an automatic machine learning (ML) model builder application 150. The automatic machine learning (ML) model builder application 150 is executable to automatically generate one or more data models (e.g., ML data models) to analyze data based on a query. For example, the automatic ML model builder application 150 may be executable to generate and train a neural network based on a query received from a query source 112.

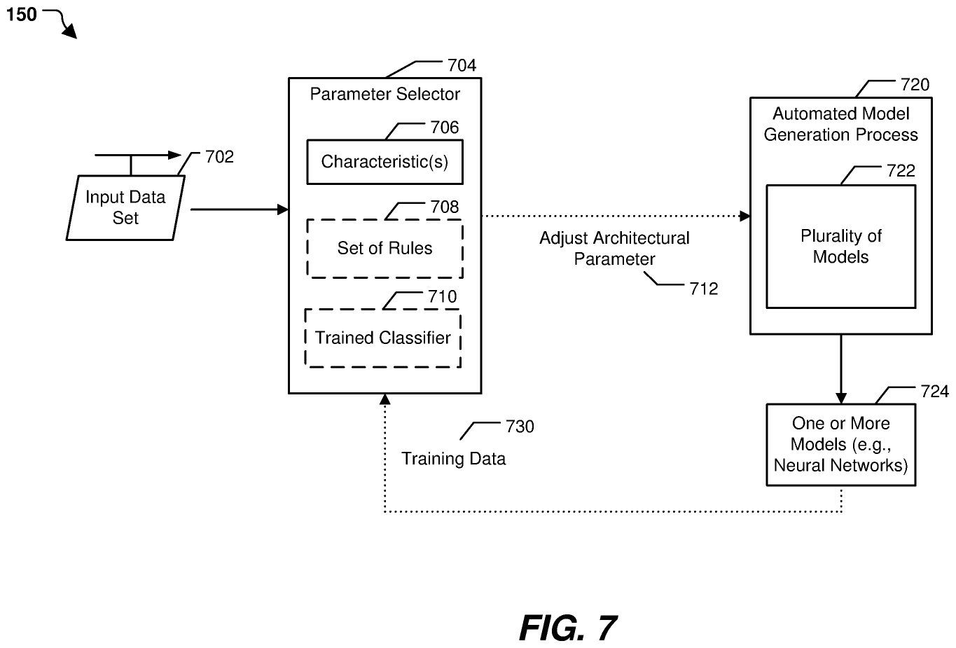

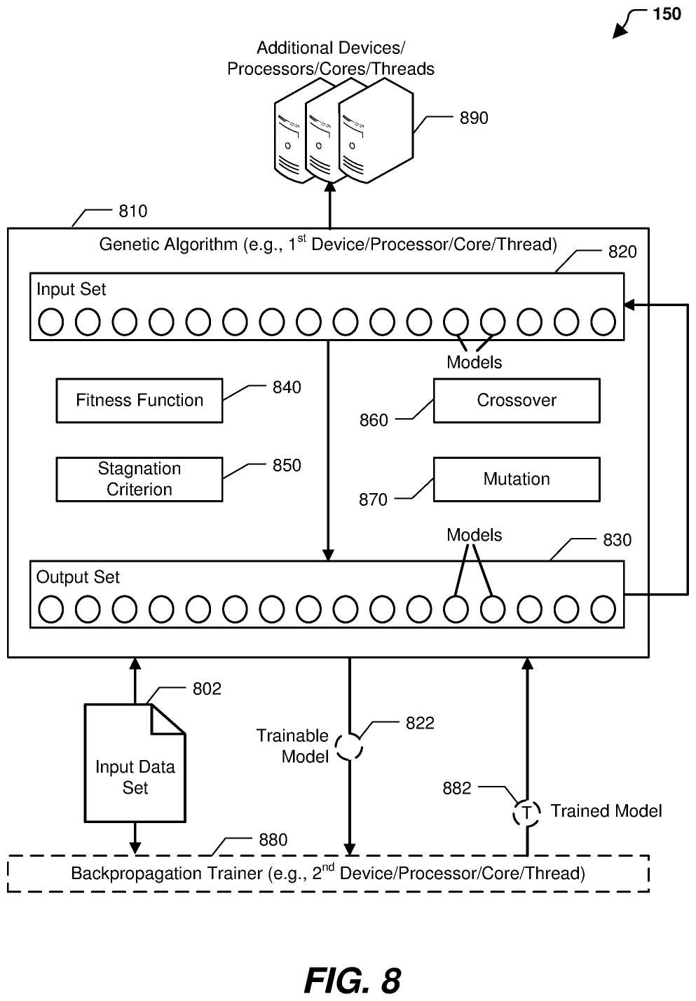

A particular process for automated model building by the automatic ML model builder application 150 is described with reference to FIGS. 7 and 8. As explained with reference to FIGS. 7 and 8, different types of data models (e.g., different architectures of neural networks) are better suited for different types of tasks. To enable the automated model building process to generate a variety of types of data models depending upon the particular task presented, an evolutionary methodology used by the automated model building process can automatically adjust architectural parameters of an automated model building process. The architectural parameters are automatically adjusted based on characteristics of an input data set (e.g., a data set accessed in response to a query). Adjusting the architectural parameters operates to reduce the search space for a reliable neural network to solve a given problem. Parameters of an automatic model building process may be biased to increase the probability that certain types of neural networks are used during evolution (e.g., as part of an initial set of models or a set of models generated during a later epoch). Thus, adjusting the architectural parameters based on characteristics of the input data set can result in the automated model building process focusing on types of ML models that are particularly suited to processing the input data set, which can reduce the amount of time and processing resources used by the automated model building process to converge on an acceptable ML model (e.g., a neural network that satisfies a fitness or other criteria).

To illustrate, an input data set requested by a query is analyzed to determine characteristics of the input data set. The characteristics may indicate a data type of the input data set, a problem to be solved (e.g., a type of analysis task indicated by the query) using the input data set, etc. For example, if the input data set includes time-series floating point data (e.g., temperatures experienced in a particular geographic region), the characteristics may indicate that the input data set is timestamped and sequential and that the input data set includes continuous values (as compared to categorical values). Based on the characteristics of the input data set, one or more parameters of an automated model building process are selected for adjustment.

In a particular implementation, the characteristics are compared to a set of rules that maps characteristics of data sets to ML model grammars (e.g., neural network grammars) As used herein, a ML model grammar is a list of rules that specify a type, a topology, or an architecture of a ML model. Based on the grammars that are associated with the characteristics in the set of rules, one or more types of ML models (e.g., a neural network, a support vector machine, a decision tree, etc.) and/or one or more architectural parameters are selected. In this implementation, the set of rules may be generated based on analysis of a plurality (e.g., hundreds or thousands) of previously generated ML models. In an alternate implementation, a classifier is generated and trained using data representative of previously generated ML models and the classifier is configured to output a ML model grammar based on the characteristics of the input data.

After selecting the type of ML model and the one or more architectural parameters, the one or more architectural parameters are adjusted to weight a randomization process (e.g., a genetic algorithm) to adjust a probability of generation of models (e.g., neural networks) having particular architectural features. For example, if the ML model type is a neural network and the characteristics of the input data are associated with recurrent structures, either in the set of rules or by the trained classifier, an architectural parameter corresponding to recurrent structures (e.g., recurrent neural networks (RNNs), long short-term memory (LSTM) layers, gated recurrent unit (GRU) layers, as non-limiting examples) is adjusted to increase the likelihood that neural networks having recurrent structures are included in the randomization process. To further illustrate, a weight associated with recurrent structures may be increased, which increases the likelihood that neural networks having recurrent structures (as opposed to other randomly selected neural networks) are included in the randomization process. As another example, if the set of rules (or the trained classifier) indicates that feedforward layers have a negative correspondence to the characteristics of the input data set, an architectural parameter corresponding to feedforward layers is adjusted to decrease the likelihood that neural networks having feedforward layers are included in the randomization process. Thus, a randomization process can be weighted (through adjustment of the architectural parameters) to focus the randomization process on particular types of neural networks that are expected to perform well given the characteristics of the input data set, which can increase the speed and reduce the amount of processing resources used by the automated model building process in converging on an acceptable neural network.

After the automated model building process converges on an acceptable neural network, the neural network can be further refined by training the neural network. For example, if the query indicates that a forecast is to be generated as output (e.g., a traffic forecast or a weather forecast), a portion of the historical data from the data repositories 110 can be used as training data to further refine and train the neural network. A different portion of the historical data from the data repositories 110 can be used to validate the neural network after it is trained. After the neural network is automatically generated in response to the query, automatically trained and validated using historical data from the data repositories 110, the neural network can be added to the data models 156 in the memory devices 116 and used to generate a query result in response to the query.

Although the example above describes the automatic ML model builder application 150 generating a neural network in response to a query related to time series data, in other circumstances the automatic ML model builder application 150 can build another type of ML model based on the query relating to another type of data. For example, the data repositories 110 can include text describing events that have occurred or are scheduled to occur in the geographic region, and a user may be interested in identifying among the events sets of concerts that feature music in the same genre (e.g., rock concerts, classical concerts, etc.). In this example, if the genre types are not pre-defined and the event listings do not all specify their genre, one way to identify the sets of concerts in the same genre is using a clustering data model. For example, the NL processing application 160 can be used to generate feature vectors based on text descriptive of the events identified in the data repositories 110, and the automatic ML model builder application 150 can perform an unsupervised clustering operations using the feature vectors to assign each concert to an unlabeled cluster. After the clustering operation, each cluster is associated with one or more concerts. The NL processing application 160 can be used to identify a subset of concerts that specify a genre of music featured. A genre label (or more than one genre label) associated with a concert assigned to a particular cluster is then assigned to the particular cluster. Thus, if a first concert and a second concert are assigned to a particular cluster, and the second concert is labeled as a classical concert, the genre label of the second concert is used to label all other concerns in the particular cluster, including the first concert. Thus, the automatic ML model builder application 150 can generate a variety of types of ML models, automatically, based on a specific type of data requested via a query, a specific type of analysis to be performed using the data, or both.

After the automatic ML model builder application 150 generates a new data model responsive to a query, the new data model is used to respond to the query and is stored (as one of the data models 156) for future use. The APIs 154 can call the automatic ML model builder application 150, one or more of the data models 156, the image analysis applications 158, the NL processing application 160, or a combination thereof to response to a particular query.

As described above, the APIs 154 can be used to build custom user applications to access and analyze the data in the data repositories 110. Thus, the system 100 provided an architecture for data analysis of geographic data and associated context data from the data repositories 110. Several specific use case examples are described below.

### First Use Case Example

In a first example, the disclosed architecture can support development of custom transportation applications. There are a variety of transportation applications that provide navigation, trip planning, ride sharing, and other services; however, with the rich data available from the data repositories 110 of FIG. 1, new types of transportation applications can be supported and existing types of transportation applications can be enriched and improved. For example, while some existing navigation and route planning applications use feedback from other users to estimate traffic, data in the data repositories 110 can be used to forecast traffic conditions in a manner that can account for relatively rare or sporadic situations. To illustrate, an accurate forecast of traffic conditions near a football stadium can be determined based on event calendar information indicating which teams are playing, past ticket sales trends for the teams and the stadium, when the game starts, when the game is expected to end, a current score of the game, weather information, and similar information regarding other events taking place near the stadium (e.g., a trade show occurring near the stadium). Note that the various information listed above is merely illustrative, and more, less, or different information may be used to estimate traffic. If the automatic ML model builder application 150 is used to generate the data model used for the traffic projection, the automatic ML model builder application 150 can automatically select which data in the data repositories 110 is correlated with traffic conditions, and automatically select the data to be used to generate the traffic projection.

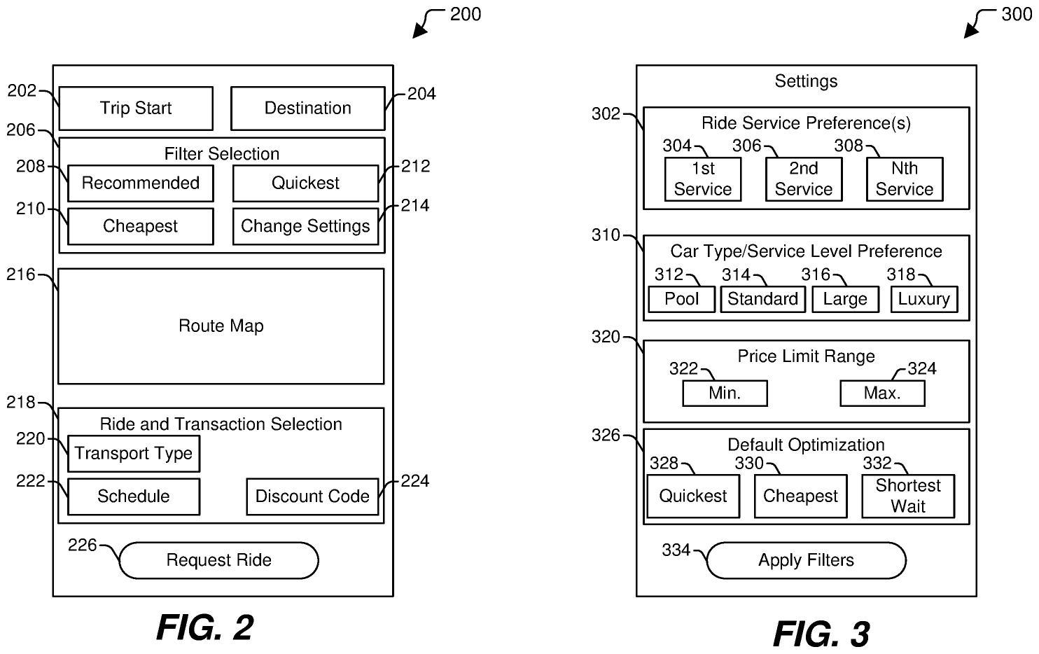

FIGS. 2-5 illustrate examples of user interfaces of a ride sharing application that uses the system of FIG. 1 to perform data analysis of geographic data and associated context data in accordance with one or more aspects disclosed herein. The ride sharing application combines information from multiple data sources (e.g., two or more other ride sharing services, a public transportation system, a traffic projection system, etc.) to give a user a recommendations and information related to selecting a ride sharing service or another transportation service to use.

In FIG. 2, a first user interface 200 can be used to request information for a particular leg of a trip. The first user interface 200 includes a plurality of user selectable fields which can be implemented as buttons, pulldown menus, text fields, radio buttons, soft buttons, or other input fields presented via a graphical user interface on a user device (e.g., a smart phone, a tablet, a notebook computer, a desktop computer, etc.).

The selectable fields include a trip start field 202 to indicate a starting location for the trip, and a destination field 204 to indicate an ending location of the trip. The selectable fields also include a filter selection menu to enable the user to specify how information presented should be ordered or filtered. In FIG. 2, the filter selections include a recommended selection 208, a cheapest selection 210, a quickest selection 212, and a change settings selection 214. FIG. 3 shows an example of a user interface (e.g., a second user interface 300) that can be displayed responsive to selection of the change settings selection 214.

In the example of FIG. 2, selecting the cheapest selection 210 indicates that the user prefers to see less expensive travel options before (or instead of) more expensive travel options. For example, the system 100 can dynamically determine or estimate travel expenses based on local population density in areas through which travel will take place, number and locations of various travel mode facilities (e.g., bus stops, train stations, taxi stands, etc.), tolls, traffic, distances of various routes, or combinations thereof.

In the example illustrated in FIG. 2, selecting the quickest selection 212 indicates that the user prefers to see travel options with a shorter estimated travel duration before (or instead of) travel options with a longer estimated travel duration. Selecting the recommended selection 208 indicates that the user prefers to see automatically recommended travel options, which could be based on a combination of factors, such as user satisfaction ratings, how scenic a route is used, projected safety of the route, travel duration, cost, previous user selections or feedback, etc.

The first user interface 200 in FIG. 2 also includes a route map 216 indicting a projected travel route based on user input received via the trip start field 202, the destination field 204, and the filter selections 206. For example, if the user selects the quickest selection 212 a route that uses a freeway with tolls may be shown in the route map 216; however, if the user selects the cheapest selection 210, a route that avoids tolls may be shown in the route map 216. In some implementations, the route map 216 can illustrate more than one route.

The first user interface 200 in FIG. 2 also includes ride and transaction selections 218. The ride and transaction selections 218 include, for example, a car type field 220, a schedule field 222, and a discount code field 224. The car type field 220 allows the user to specify one or more types of transportation that are to be considered when planning the trip. To illustrate, the type of transportation can include public transportation (e.g., trains and buses), bicycle sharing programs, scooter sharing programs, taxis, automobile ride sharing service, etc. The schedule field 222 allows the user to specify a future time or time range in which the trip will occur. The discount code field 224 allows the user to provide a discount code (or indicate that the user has a discount code for a particular transportation service), which can be considered when planning the trip. For example, the trip may be more expensive using a first transportation service that using a second transportation service until the discount code is taken into account.

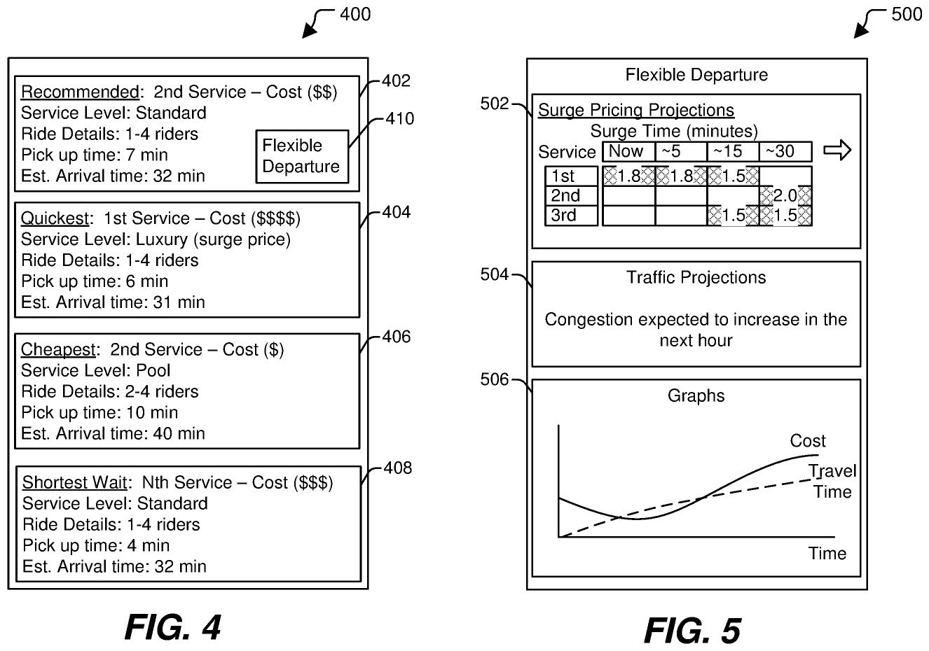

The first user interface 200 in FIG. 2 also includes a request ride field 226 which can be selected to send a query for ride options based on the trip options specified via input in the first user interface 200. FIG. 4 shows an example of a user interface (e.g., a third user interface 400) that can be displayed responsive to selection of the request ride field 226.

In FIG. 3, a second user interface 300 can be used to change the filter settings (e.g., responsive to selection of the change settings selection 214 of FIG. 2). The second user interface 300 includes non-limiting examples of a plurality of user selectable fields that can be used to specify travel preferences of the user. In FIG. 3, the selectable options pertain to ride service preferences 302, car type/service level preferences 310, a price limit range 320, and default optimization options 326. The illustrated set of selectable options is merely illustrative. In other implementations, other sets of selectable options can be included, some of the illustrated selectable options can be omitted, or both. For example, in some implementations, the second user interface 300 can includes fields to specify options related to public transportation. The second user interface 300 also includes an apply filters selection 334 that can be selected to implement settings specified in the second user interface 300.

The ride service preferences 302 allow the user to indicate a preference for one ride service over another. In the second user interface 300, the ride service preferences 302 include fields associated with three services (i.e., a first service field 304 associated with a first ride service, a second service field 306 associated with a second ride service, and an Nth service field 308 associated with an Nth ride service). The ride services can include ridesharing services, taxi services, or other transportation services. The user can select a particular ride service field to indicate a preference for the associated ride service over other listed ride services. Alternatively, the user can arrange the ride services in order of preference (e.g., from right to left with the most preferred further right and the least preferred furthest left). If the user never wants a particular ride service to be considered, the user can delete the ride service field associated with the particular ride service (e.g., by dragging an icon associated with the ride service field off of the display screen).

The car type/service level preferences 310 allows the user to indicate a preference for a particular level of service for the ride service. In the second user interface 300, the car type/service level preferences 310 include a pool field 312 associated with a carpool service level, a standard field 314 associated with a standard service level, a large field 316 associated with a large vehicle type, and a luxury field 318 associated with a luxury vehicle type, a luxury service level, or both.

The price limit range 320 allows the user to indicate a range of prices for filter setting. In FIG. 3, the price limit range 320 includes a minimum price field 322 to specify a minimum trip price and a maximum price field 324 to specify a maximum trip price.

The default optimization options 326 allows the user to specify a particular type of optimization that is to be used by default when planning a trip. In FIG. 3, the default optimization options 326 include a quickest option 328, a cheapest option 330, and a shortest wait option 332. The quickest option 328 and the cheapest option 330 correspond to the quickest selection 212 and the cheapest selection 210, respectively, of FIG. 2 and operate as described above. The shortest wait option 332 optimizes trip recommendations based on how long the user has to wait to be picked up and favors travel options that have shorter wait times over travel options that have longer wait times.

In FIG. 4, the third user interface 400 illustrates an ordered list of travel options based on a trip specified via the first user interface 200 of FIG. 2 and relevant settings specified via the second user interface 300 of FIG. 3. In FIG. 4, each entry of the list of travel options corresponds to a ride from a ride service. However, as described above, in other implementations, other travel options can be including the list of travel options based on input or settings specified by the user. In FIG. 4, the list of travel options includes a recommended travel option entry 402, a quickest travel option entry 404, a cheapest travel option entry 406, and a shortest wait travel option entry 408. The third user interface 400 also includes a flexible departure selectable option 410, which can be selected to display additional travel information, such as the fourth user interface 500 of FIG. 5.

The fourth user interface 500 of FIG. 5 illustrates additional information that can help a user select a departure time if the user's departure time is flexible. In the example illustrated in FIG. 5, the fourth user interface 500 includes surge pricing projection data 502. Many ride services use surge pricing to increase supply (e.g., by incentivizing drivers to provide rides), decrease demand (e.g., by disincentivizing riders from requesting rides), or both, during certain periods. The surge pricing projection data 502 illustrates whether each ride service is in a surge pricing period now and provides a projection (based on a data model 156 of the system 100 of FIG. 1) of when each ride service will begin or end a surge pricing period. Projecting when surging pricing will begin or end can help a user decide whether it would be worthwhile to postpone a departure time (or advance a departure time that is scheduled for later). To illustrate, in FIG. 4, the quickest travel option entry 404 is for a luxury service level ride from the first service. FIG. 5 shows that the first service is in a surge pricing period now, but the surge pricing period is expected to end in about half an hour. Thus, if the user would like to use a luxury level of service and can delay departure, the user can wait to take the first service at a reduced price.

In FIG. 5, the fourth user interface 500 of FIG. 5 also includes a traffic projection estimate 504 that includes information about projected traffic in a future time period. The fourth user interface 500 also includes a graph 506 to assist the user with decision making. For example, the graph 506 illustrates projections for future travel cost and future travel time. Thus, the user is able to see when the best time would be to depart in terms of cost and travel time. In other implementations, other projected data can be shown in the graph 506.

### Second Use Case Example

In a second use case example, the disclosed architecture can support development of custom advertising management applications. For example, the geographic data 104 and context data 106 stored in the data repositories 110, in combination with the capability to automatically build ML data models based on specific queries, can enable advertisers to build more effective advertising campaigns or to determine how and where to advertise. For example, the system 100 can include or can generate a data model 156 to show projected population demographics over a map display. In this example, billboard locations or potential billboard locations can be indicated to assist with location selection for particular advertisement. In this example, the projected population demographics can indicate how the populations demographics are expected to change over time (e.g., in the near term, such as within a day or by day of the week based on traffic patterns and events, or in the long term, such as in the next few months or years based on building permits or road changes).

### Third Use Case Example

In a third use case example, the disclosed architecture can support city planning applications. For example, the geographic data 104 and context data 106 stored in the data repositories 110, in combination with the capability to automatically build ML data models based on specific queries, can enable city or regional planners to plan for projected changes and to model how the plan influences the projected changes. For example, the system 100 can include or can generate a data model 156 to show projected bus route ridership and locations of populations that may have unsatisfied bus route demand. In this example, the city planner could change some bus routes (e.g., by adding new routes, changing route timing, changing a number of in-service buses at different times, removing routes, etc.) based on the locations with unsatisfied bus route demand, and then project (using a ML data model) the effect of the changes. In other examples, the ML data model can also account for other information, such as scheduled events, planned road construction, capital expenditure planning (e.g., how many buses or trains should be purchased).

### Fourth Use Case Example

In a fourth use case example, the disclosed architecture can support shipping within or between geographic regions (e.g., import and export). For example, the geographic data 104 and context data 106 stored in the data repositories 110, in combination with the capability to automatically build ML data models based on specific queries, can enable a user to estimate costs of shipping particular goods to a destination using various shipping or transportation mechanisms. In this example, a data repository of the data repositories 110 can include information pertaining to a first geographic region (e.g., a first city in a first country) and a second data repository of the data repositories 110 can include information pertaining to a second geographic region (e.g., a second city in a second country). Either of these data repositories or a third data repository can include shipping information, such as cost estimates, import/export requirements, etc. A data model 156 of the system 100 can recommend how to ship particular goods from the first geographic region to the second geographic region based on the data repositories 110 and optimization or filter settings indicated by a user (e.g., in a manner similar to the ride sharing application described with reference to FIGS. 2-5 and the first use case example).

### Fifth Use Case Example

In a fifth use case example, the disclosed architecture can support dynamic transportation pricing, such as pricing of tolls, fares, parking fees, etc. For example, a transportation authority or traffic planner can provide the system 100 with access to data repositories 110 that include information such as population density of particular areas, locations associated with transportation modalities (e.g., locations of bus stops, train stations, toll booths, metered parking, high occupancy vehicle lanes, electric vehicle charging stations, etc.) and with information regarding goals to be achieved and the system 100 can generate recommendations. To illustrate, the system 100 can recommend dynamic pricing adjustments for tolls on certain roadways and bus fares in order to increase bus ridership. Other behavioral changes can also be achieved, such as increasing HOV lane usage, redirecting traffic, etc.

### Sixth Use Case Example

In a sixth use case example, the disclosed architecture can support outdoor advertising campaigns. For example, an advertisement campaign manager can provide the system 100 with access to data repositories 110 that include information such as population density of particular areas, traffic and traffic forecasts, demographics in particular areas, pricing for various advertising modalities, and advertising campaign goals. In this example, the system 100 can generate recommendations regarding advertising modalities or locations. In some implementations, the system 100 can assign an advertisement of the advertising campaign to a particular billboard during a particular time period based on the recommended adverting modalities and locations.

### Seventh Use Case Example

In a seventh use case example, the disclosed architecture can support mobile advertising. For example, extending the sixth use case, the advertisement campaign manager can use the system 100 to assign advertisements to mobile advertisement platforms (e.g., vehicles with advertisement display space). In this example, the real-time or projected locations of particular other vehicles or drivers can also be considered. For example, a truck with a mobile display can be assigned a particular advertisement based in part on the advertisement targeting one or more drivers that are near the truck with the mobile display.

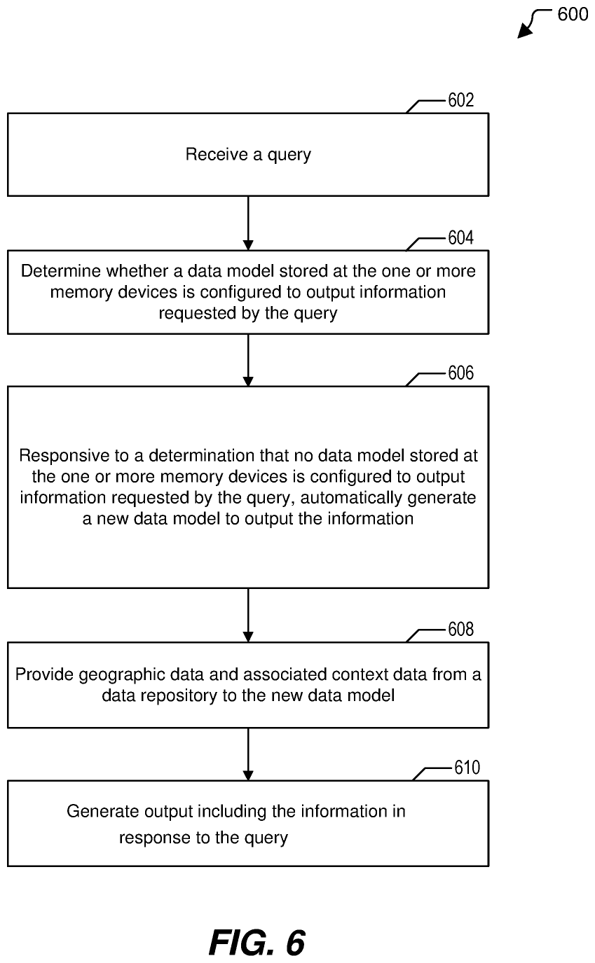

Referring to FIG. 6, a flowchart to illustrate a particular implementation of a method 600 of data analysis of geographic data and associated context data in accordance with one or more aspects disclosed herein. In a particular implementation, the method 600 can be performed by the system 100 of FIG. 1 or a component thereof, such as by the back-end systems 108 or the one or more processors 114.

The method 600 includes, at 602, receiving a query. For example, the back-end systems 108 can receive a query from one of the query sources 112.

The method 600 also includes, at 604, determining whether a pre-configured data model stored at one or more memory devices is configured to output information requested by the query. For example, some of the APIs 154 can be mapped to corresponding data models 156. If the query is received via an API 154 that is not mapped to a specific data model 156, the back-end systems 108 can attempt to map the query to a pre-configured data model 156. To illustrate, the query can be analyzed using the NL processing application 160 to determine data requested and a type of analysis to be performed (e.g., projection of a floating point value, anomaly detection, optimization, clustering or labeling data, etc.). In this illustrative example, the back-end systems 108 can determine whether any of the data models 156 stored in the memory devices 116 are configured to perform the requested type of analysis to generate the requested data. If none of the data models 156 stored in the memory devices 116 are configured to perform the requested type of analysis to generate the requested data, the back-end systems 108 determine that no pre-configured data model 156 stored at the memory devices 116 is configured to output information requested by the query.

The method 600 further includes, at 606, responsive to a determination that no pre-configured data model stored at the one or more memory devices is configured to output information requested by the query, automatically generating a data model to output the information. For example, the automatic ML model builder application 150 can be executed to generate and train a new data model, as explained above.

The method 600 also includes, at 608, providing geographic data and associated context data from a data repository to the data model. For example, after the automatic ML model builder application 150 generates and trains a new data model, the new data model can be provided with data from the data repositories 110 to enable the new data model to perform the requested analysis. The method 600 further includes, at 610, generating output including the information in response to the query. For example, the output can be provided to the query source that sent the query.

Thus, the method 600 enables query-driven analysis of geographic data and associated context data. For some queries, this can even include automatically generating a machine-learning data model to perform particular analyses. The query-driven analysis can provide users with access to a richer variety of information. Additionally, since data models generated by the automatic ML model builder application 150 are stored for future use, the method 600 can automatically build data models (e.g., software) based on user demand, which can save significant time and resources as compared to manually configuring structure queries and corresponding data analysis.

It is to be understood that the division and ordering of steps described herein and shown in the flowchart of FIG. 6 is for illustrative purposes only and is not be considered limiting. In alternative implementations, certain steps may be combined, and other steps may be subdivided into multiple steps. Moreover, the ordering of steps may change.

FIGS. 7 and 8 illustrate aspects of an automated model generation process based on characteristics of an input data set. FIGS. 7 and 8 show particular illustrative examples of the automatic machine learning model builder 150 of FIG. 1. The automatic machine learning model builder 150, or portions thereof, may be implemented using (e.g., executed by) one or more computing devices, such as laptop computers, desktop computers, mobile devices, servers, and Internet of Things devices and other devices utilizing embedded processors and firmware or operating systems, etc. In the illustrated example, the automatic machine learning model builder 150 includes a parameter selector 704 and an automated model generation process 720.

It is to be understood that operations described herein as being performed by the parameter selector 704 and the automated model generation process 720 may be performed by a device executing instructions. The instructions may be stored at a memory, such as a random-access memory (RAM), a read-only memory (ROM), a computer-readable storage device, an enterprise storage device, any other type of memory, or a combination thereof. In a particular implementation, the operations described with reference to the parameter selector 704 and the automated model generation process 720 are performed by a processor (e.g., a central processing unit (CPU), graphics processing unit (GPU), or other type of processor). In some implementations, the operations of the parameter selector 704 are performed on a different device, processor (e.g., CPU, GPU, or other type of processor), processor core, and/or thread (e.g., hardware or software thread) than the automated model generation process 720. Moreover, execution of certain operations of the parameter selector 704 or the automated model generation process 720 may be parallelized.

The parameter selector 704 is configured to receive an input data set 702 (e.g., from one of the data sources 102 or the data repositories 110 of FIG. 1) and to determine one or more characteristics 706 of the input data set 702. The characteristics 706 may indicate a data type of the input data set 702, a problem to be solved for the input data set 702, a size of the input data set 702, other characteristics associated with the input data set 702, or a combination thereof. The parameter selector 704 is further configured to adjust an architectural parameter 712 of the automated model generation process 720 based on the characteristics 706. In a particular implementation, the parameter selector 704 is configured to select the architectural parameter 712 using a set of rules 708, as further described herein. In another particular implementation, the parameter selector 704 is configured to select the architectural parameter 712 using a trained classifier 710, as further described herein.

The automated model generation process 720 is configured to generate a plurality of models 722 using a weighted randomization process. In a particular implementation, the automated model generation process 720 includes a genetic algorithm. In this implementation, the plurality of models 722 include one or more sets of models generated during one or more epochs of the genetic algorithm. For example, the plurality of models 722 may include a set of initial models used as input to a first epoch of the genetic algorithm, a set of models output by the first epoch and used as input to a second epoch of the genetic algorithm, and other sets of models output by other epochs of the genetic algorithm. The automated model generation process 720 is configured to generate sets of models during each epoch using the weighted randomization process. For example, if all the weights of the architectural parameters are the same, the automated model generation process 720 generates an initial set of models by randomly (or pseudo-randomly) selecting models having various architectures, and the initial set of models are evolved across multiple epochs. As a particular example, one or more models may be mutated or crossed-over (e.g., combined) during a first epoch to generate models of an output set of the first epoch. The output set is used as an input set to a next epoch of the automated model generation process 720. Additional epochs continue in this manner, by evolving (e.g., performing genetic operations on) an input set of models to generate an output set of models.

The architectural parameter 712 weights the weighted randomization process of the automated model generation process 720 to control a probability of generation of models having particular architectural features. For example, if the architectural parameter 712 corresponds to recurrency, the architectural parameter 712 can be adjusted (e.g., by increasing a weight) to increase a probability of generation of recurrent models by the weighted randomization process. As another example, if the architectural parameter 712 corresponds to pooling, the architectural parameter 712 can be adjusted (e.g., by decreasing a weight) to decrease the probability of generation of pooling-based models by the weighted randomization process. The architectural parameter 712 is adjusted based on the characteristics 706, as further described herein.

The automated model generation process 720 is configured to generate the plurality of models 722 during performance of the automated model generation process 720 (e.g., during multiple epochs of the genetic algorithm). The automated model generation process 720 is further configured to output one or more models 724 (e.g., data indicative of one or more neural networks). In a particular implementation, the automated model generation process 720 is configured to execute for a set amount of time (e.g., a particular number of epochs), and the one or more models 724 are the “fittest” models generated during the last epoch of the automated model generation process 720. Alternatively, the automated model generation process 720 may be executed until the automated model generation process 720 converges on one or more models having fitness scores that satisfy a fitness threshold. The fitness scores may be based on a frequency and/or a magnitude of errors produced by testing the one or more models 724 on a portion on the input data set 702. For example, if the one or more models 724 are trained, based on the input data set 702 to predict a value of a particular feature, the fitness score may be based on the number of correctly predicted features for a testing portion of the input data set 702 compared to the total number of features (both correctly and incorrectly predicted). Additionally, or alternatively, the fitness score may indicate characteristics of the model, such as a density (e.g., how many layers are included in the neural network, how many connections are included in the neural network, etc.) of the model. Additionally, or alternatively, the fitness score may be based on the amount of time taken by the automated model generation process 720 to converge on the one or more models 724. Data indicative of the one or more models 724, such as data indicating an architecture type of the one or more models 724, the fitness score, or a combination thereof, can be used as training data 730 to train the parameter selector 704.

The execution of the automated model generation process 720 results in the one or more models 724 (e.g., outputs). The one or more models 724 are executable by the processor that executes the automated model generation process 720 (or by another processor or by another device) to perform an operation, such as classification, clustering, anomaly detection, or some other type of operation based on input data. Stated another way, the automated model generation process 720 uses an unknown data set (e.g., the input data set 702) to generate software (e.g., the one or more models 724) that is configured to perform one or more operations based on related data sets. As a particular non-limiting example, if the input data set 702 includes time-series data from a sensor of a device, the automated model generation process 720 may be executed to train a neural network that can be executed by a processor to perform anomaly detection based on real-time (or near real-time) time-series data from the sensor. Because the automated model generation process 720 is biased to include models having particular architectural types (or to exclude models having particular architectural types), the one or more models 724 may be generated faster than compared to a model generation process that randomly selects models for use during the model generation process. Additionally, the one or more models 724 may have a higher fitness score than models that are generated using other model generation techniques.

During operation, the parameter selector 704 receives the input data set 702. The input data set 702 includes a plurality of features. The input data set 702 may include input data (e.g., features) for which one or more neural networks are to be trained to solve a problem.

The parameter selector 704 determines the characteristics 706 based on the input data set 702. In a particular implementation, the characteristics 706 indicate a type of problem associated with the input data set, a data type associated with the input data set, or a combination thereof. To illustrate, in a particular example, the input data set 702 includes time-series data. In this example, the characteristics 706 include that the input data set 702 is time-stamped and sequential, and that the input data set 702 includes continuous features (e.g., numerical features). As another example, the input data set 702 includes data for a classification task. In this example, the characteristics 706 include that the data includes one or more categorical features and that the data is indicated for classification. As yet another example, if the input data set 702 includes image data, the characteristics 706 indicate that a data type of the input data set 702 includes image data.

The parameter selector 704 adjusts the architectural parameter 712 based on the characteristics 706. For example, the characteristics 706 may correspond to one or more types of architectures of neural networks, and the parameter selector 704 may select and adjust the architectural parameter 712 to weight the weighted randomization process of the automated model generation process 720 to adjust a probability of generation of models having the one or more types of architectures.

In a particular implementation, the parameter selector 704 selects the architectural parameter 712 using the set of rules 708. For example, the parameter selector 704 may store or have access to the set of rules 708. In this implementation, the set of rules 708 maps characteristics of data sets to architectural parameters. For example, the set of rules 708 may map characteristics of data sets to grammars that indicate architectural parameters of neural networks. As a particular example, the set of rules 708 may map characteristics of standard (or “flat”) supervised problems to architectural parameters corresponding to densely connected feedforward layers. As another example, the set of rules 708 may map characteristics of sequence problems to recurrent structures (such as recurrent neural networks (RNNs), long short-term memory (LSTM) layers, or gated recurrent units (GRU) layers, as non-limiting examples). As another example, the set of rules 708 may map characteristics of image problems (e.g., input image data) to pooling-based 2D convolutional neural networks. As another example, the set of rules 708 may map characteristics of industrial time series data to daisy chains of causal convolutional blocks. In a particular implementation, the set of rules 708 is based on analysis of a plurality of models that were previously generated by the automated model generation process 720, based on analysis of other models, or a combination thereof.

In a particular implementation, the set of rules 708 includes weight values. For example, a first rule may map a first characteristic to a first architectural parameter with a first weight value, and a second rule may map the first characteristic to a second architectural parameter with a second weight value. For example, time series data may be mapped to daisy chains of causal convolutional weight values with a first weight value, and the time series data may be mapped to recurrent structures with a second weight value. The weight value indicates how much the parameter selector 704 will adjust the architectural parameter. For example, if the second weight value is less than the first weight value, the parameter adjuster will adjust architectural parameters such that the probability of models having daisy chains of causal convolution blocks is greater than the probability of models having recurrent structures. In some implementations, the weight may be negative. For negative weights, the parameter selector 704 may adjust the architectural parameter 712 to reduce the probability that models have the particular architectural feature.

In another particular implementation, the parameter selector 704 selects the architectural parameter 712 using the trained classifier 710. To illustrate, the parameter selector 704 provides data indicative of the characteristics 706 to the trained classifier 710, and the trained classifier 710 identifies one or more architectural parameters for adjustment based on the data indicative of the characteristics 706. The trained classifier 710 may be trained based on data indicative of previous models generated by the automated model generation process 720 (e.g., data indicative of architectural types of the previous models) and data indicative of characteristics of the input data used to train the previous models. For example, characteristics of input data may be labeled with an architectural parameter corresponding to the model generated for the input data, and this labeled data may be used as supervised training data to train the trained classifier 710 to identify architectural parameters based on characteristics of input data. In a particular implementation, the trained classifier 710 includes a neural network classifier. In other implementations, the trained classifier 710 includes a decision tree classifier, a support vector machine classifier, a regression classifier, a naive Bayes classifier, a perceptron classifier, or another type of classifier.

After selecting the architectural parameter 712, the parameter selector 704 adjusts the architectural parameter 712 to adjust a probability of generation of models (by the automated model generation process 720) having particular architectural features. In a particular implementation, the architectural feature includes an initial model type used by the weighted randomization process of the automated model generation process 720. The initial model type may include feedforward models, recurrent models, pooling-based two-dimensional convolutional models, daisy-chains of causal convolutional models, other types of models, or a combination thereof. To illustrate, the parameter selector 704 may set the architectural parameter 712 to a first value based on the characteristics 706, the first architectural parameter associated with a probability that models of a first epoch of the weighted randomization process have a first model type, and the parameter selector 704 may set a second architectural parameter to a second value based on the characteristics 706, the second architectural parameter associated with a probability that models of the first epoch of the weighted randomization process have a second model type.

As an example, the characteristics 706 may indicate that the input data set 702 includes image data. In this example, the set of rules 708 (or the trained classifier 710) indicate that pooling-based 2D convolutional neural networks have a positive correspondence with image data and that densely connected feedforward layers have a negative correspondence with image data. Based on the characteristics 706, the parameter selector 704 selects the architectural parameter 712 (corresponding to pooling-based 2D convolutional neural networks) and a second architectural parameter (corresponding to densely connected feedforward layers) for adjustment. In this example, the parameter selector 704 adjusts the architectural parameter 712 to increase the probability that the plurality of models 722 include pooling-based 2D convolutional neural networks. In this example, the parameter selector 704 also adjusts the second architectural parameter to decrease the probability that the plurality of models 722 include models having densely connected feedforward layers. Adjusting the architectural parameters in this manner may cause the automated model generation process 720 to converge faster on the one or more models 724 using fewer processing resources, because models that are more likely to be successful have a higher likelihood of being generated and used in the automated model generation process 720 (and models that are less likely to be successful have a lower likelihood of being generated).

The architectural parameter 712 may also include a mutation parameter. A mutation parameter controls mutation that occurs during the automated model generation process 720, such that at least one model of the plurality of models 722 is modified based on the mutation parameter. For example, mutation may occur to one or more models during an epoch of the automated model generation process 720. Mutation includes changing at least one characteristic of the model. The mutation parameter indicates how likely mutation is to occur, what type of mutation is likely to occur (e.g., what characteristic is likely to change), or both. The mutation parameter may be adjusted based on the characteristics 706. For example, the set of rules 708 (or the trained classifier 710) may indicate an adjustment to a mutation parameter that corresponds to the characteristics 706, and the mutation parameter (e.g., the architectural parameter 712) may be adjusted accordingly.

In a particular implementation, the parameter selector 704 also selects and adjusts one or more training hyperparameters of the automated model generation process 720. The one or more training hyperparameters control one or more aspects of training of the model. As used herein, a hyperparameter refers to a characteristic that determines how a model is trained. For example, a hyperparameter may include a learning rate of a neural network (e.g., how quickly a neural network updates other parameters), momentum of a neural network, a number of epochs of the automated model generation process 720, a batch size, or a combination thereof. The parameter selector 704 may adjust the hyperparameter based on the characteristics 706. For example, the set of rules 708 (or the trained classifier 710) may indicate that a particular hyperparameter corresponds to the characteristics 706, and the parameter selector 704 may adjust the particular hyperparameter accordingly.

After the architectural parameter 712 is adjusted, the automated model generation process 720 is executed. For example, a processor executes the automated model generation process 720. During execution of the automated model generation process 720, the plurality of models 722 are generated. The plurality of models 722 are generated using a weighted randomization process, where architectural parameters control the weights. For example, if a particular architectural parameter has a higher weight than another architectural parameter, models having a particular architectural type have a higher probability of being included in an initial set (or other set) of models generated by the automated model generation process 720. The plurality of models 722 includes an initial set of models generated as input to an initial epoch as well as other sets of models generated as output sets of one or more epochs. The automated model generation process 720 may be executed until the automated model generation process 720 converges on the one or more models 724. As an example, the one or more models 724 may be the fittest model(s) of a last epoch of the automated model generation process 720. In a particular implementation, the number of epochs of the automated model generation process 720 is set prior to execution of the automated model generation process 720, and the one or more models 724 are taken from the output set of the last epoch. Alternatively, the automated model generation process 720 may be executed for a particular amount of time (e.g., until a time limit has expired). Alternatively, the automated model generation process 720 may be executed until at least one model of an output set has a score that satisfies a threshold (e.g., until the automated model generation process 720 converges on an acceptable model), and the one or more models 724 are the one or more models that satisfy the threshold. Thus, the one or more models 724 may be referred to as the output of the automated model generation process 720.

The one or more models 724 are trained to perform a task based on input data. As a particular example, the one or more models 724 may be trained based on the input data set 702 to perform a classification task. To further illustrate, the input data set 702 may include time-series data indicative of various detected states, and the one or more models 724 may be trained to identify a state (or to predict a state) based on real-time time series input data. These examples are non-limiting, and in other implementations the one or more models 724 are trained to perform other machine learning tasks.

In some implementations, after the one or more models 724 are generated and trained, data indicative of the one or more models 724 is provided as the training data 730 to update the parameter selector 704. The training data 730 indicates characteristics, such as architecture types of the one or more models 724. Updating the parameter selector 704 based on the training data 730 enables the parameter selector 704 to account for the success of the one or more models 724 generated by the automated model generation process 720.

In a particular implementation, the parameter selector 704 updates the set of rules 708 based on the training data 730 (e.g., based on the characteristics of the one or more models 724). In some implementations, the set of rules 708 are updated responsive to scores of the one or more models 724 satisfying a threshold. For example, if fitness scores of the one or more models 724 satisfy (e.g., are greater than or equal to) a first threshold, the set of rules 708 may be updated to indicate a correspondence between the characteristics 706 and architectural parameters indicating architectural types of the one or more models 724. If the set of rules 708 already indicate a correspondence between the characteristics 706 and the architectural parameters, a weighting associated with the architectural parameter may be increased. As another example, if fitness scores of the one or more models 724 fail to satisfy (e.g., are less than) a second threshold, the set of rules 708 may be updated to indicate a negative correspondence between the characteristics 706 and architectural parameters indicating architectural types of the one or more models 724. If the set of rules 708 already indicates a correspondence between the characteristics 706 and the architectural parameters, a weighting associated with the architectural parameters may be decreased. Thus, the set of rules 708 may be updated to account for the success (or lack thereof) of the one or more models 724.

In an alternate implementation, the parameter selector 704 uses the training data 730 as training data to retrain the trained classifier 710. For example, the training data 730 may include data corresponding to the characteristics 706 and a label indicating an architectural parameter corresponding to architectural types of the one or more models 724. In this example, the training data 730 is used as labeled training data to update the trained classifier 710. In a particular implementation, the trained classifier 710 is updated only if fitness scores of the one or more models 724 satisfy (e.g., are greater than or equal to) a first threshold. Additionally, or alternatively, an alternate label (e.g., indicating a negative correspondence) may be used if the fitness scores of the one or more models 724 fail to satisfy (e.g., are less than) a second threshold. Thus, the trained classifier 710 may be trained to account for the success (or lack thereof) of the one or more models 724.

In the example illustrated in FIG. 7, the automated model generation process 720 converges on the one or more models 724 faster than other model generation processes. For example, the architectural parameter 712 may be adjusted based on the characteristics 706 to increase the probability that an initial set of models of the automated model generation process 720 includes models having architectural types that were previously successful for similar input data sets. These models may be fitter than other types of models at modeling the input data set 702. Increasing the probability that models having higher fitness are included in the initial set of models may decrease the number of epochs needed to converge on an acceptable neural network (e.g., the one or more models 724), thereby increasing speed of the automated model generation process 720 and decreasing the amount of processing resources utilized by the automated model generation process 720. Additionally, because fitter models are introduced in the initial set of models, the overall fitness of the one or more models 724 may be improved as compared to model generation processes that randomly determine the initial set of models. The architectural parameter 712 can be adjusted by an amount that still maintains some randomness in the selection of the initial input set in order to try models having different architectural parameters in case there is a type that has not yet been tried for the input data set 702 that performs better than those that have been previously tried. Adjusting a mutation parameter, or a hyperparameter, based on the characteristics 706 can similarly improve the speed of the automated model generation process 720 and reduce the amount of processing resources used by the automated model generation process 720.

In FIG. 8, a neural network topology may be “evolved” using a genetic algorithm 810. The genetic algorithm 810 automatically generates a neural network based on a particular data set, such as an illustrative input data set 802, and based on a recursive neuroevolutionary search process. In an illustrative example, the input data set 802 is the input data set 702 shown in FIG. 7. During each iteration of the search process (also called an “epoch” or “generation” of the genetic algorithm 810), an input set 820 (or population) is “evolved” to generate an output set 830 (or population). Each member of the input set 820 and the output set 830 is a model (e.g., a data structure) that represents a neural network. Thus, neural network topologies can be evolved using the genetic algorithm 810. The input set 820 of an initial epoch of the genetic algorithm 810 may be randomly or pseudo-randomly generated. In a particular implementation, the input set 820 of the initial epoch of the genetic algorithm 810 is generated based on one or more architectural parameters, which weight the selection of the input set 820 toward selection of particular neural network architectures, as described with reference to FIG. 7. After that, the output set 830 of one epoch may be the input set 820 of the next (non-initial) epoch, as further described herein.

The input set 820 and the output set 830 each includes a plurality of models, where each model includes data representative of a neural network. For example, each model may specify a neural network by at least a neural network topology, a series of activation functions, and connection weights. The topology of a neural network includes a configuration of nodes of the neural network and connections between such nodes. The models may also be specified to include other parameters, including but not limited to bias values/functions and aggregation functions.

In some examples, a model of a neural network is a data structure that includes node data and connection data. The node data for each node of a neural network may include at least one of an activation function, an aggregation function, or a bias (e.g., a constant bias value or a bias function). The activation function of a node may be a step function, sine function, continuous or piecewise linear function, sigmoid function, hyperbolic tangent function, or another type of mathematical function that represents a threshold at which the node is activated. The biological analog to activation of a node is the firing of a neuron. The aggregation function is a mathematical function that combines (e.g., sum, product, etc.) input signals to the node. An output of the aggregation function may be used as input to the activation function. The bias is a constant value or function that is used by the aggregation function and/or the activation function to make the node more or less likely to be activated. The connection data for each connection in a neural network includes at least one of a node pair or a connection weight. For example, if a neural network includes a connection from node N1 to node N2, then the connection data for that connection may include the node pair <N1, N2>. The connection weight is a numerical quantity that influences if and/or how the output of N1 is modified before being input at N2. In the example of a recurrent neural network, a node may have a connection to itself (e.g., the connection data may include the node pair <N1, N1>).

The genetic algorithm 810 includes or is otherwise associated with a fitness function 840, a stagnation criterion 850, a crossover operation 860, and a mutation operation 870. The fitness function 840 is an objective function that can be used to compare the models of the input set 820. In some examples, the fitness function 840 is based on a frequency and/or magnitude of errors produced by testing a model on the input data set 802. As a simple example, assume the input data set 802 includes ten rows, that the input data set 802 includes two columns denoted A and B, and that the models illustrated in FIG. 8 represent neural networks that output a predicted value of B given an input value of A. In this example, testing a model may include inputting each of the ten values of A from the input data set 802, comparing the predicted values of B to the corresponding actual values of B from the input data set 802, and determining if and/or by how much the two predicted and actual values of B differ. To illustrate, if a particular neural network correctly predicted the value of B for nine of the ten rows, then a relatively simple fitness function 840 may assign the corresponding model a fitness value of 9/10=0.9. It is to be understood that the previous example is for illustration only and is not to be considered limiting. In some aspects, the fitness function 840 may be based on factors unrelated to error frequency or error rate, such as number of input nodes, node layers, hidden layers, connections, computational complexity, etc.

In a particular aspect, fitness evaluation of models may be performed in parallel. To illustrate, the illustrated system may include additional devices, processors, cores, and/or threads 890 to those that execute the genetic algorithm 810. These additional devices, processors, cores, and/or threads 890 may test model fitness in parallel based on the input data set 802 and may provide the resulting fitness values to the genetic algorithm 810.

In a particular aspect, the genetic algorithm 810 may be configured to perform speciation. For example, the genetic algorithm 810 may be configured to cluster the models of the input set 820 into species based on “genetic distance” between the models. Because each model represents a neural network, the genetic distance between two models may be based on differences in nodes, activation functions, aggregation functions, connections, connection weights, etc. of the two models. In an illustrative example, the genetic algorithm 810 may be configured to serialize a model into a string, such as a normalized vector. In this example, the genetic distance between models may be represented by a binned hamming distance between the normalized vectors, where each bin represents a subrange of possible values.

Because the genetic algorithm 810 is configured to mimic biological evolution and principles of natural selection, it may be possible for a species of models to become “extinct.” The stagnation criterion 850 may be used to determine when a species should become extinct, as further described below. The crossover operation 860 and the mutation operation 870 may be highly stochastic under certain constraints and a defined set of probabilities optimized for model building, which may produce reproduction operations that can be used to generate the output set 830, or at least a portion thereof, from the input set 820. Crossover and mutation are further described below.

Operation of the illustrated system is now described. It is to be understood, however, that in alternative implementations certain operations may be performed in a different order than described. Moreover, operations described as sequential may be performed at least partially concurrently, and operations described as being performed at least partially concurrently may be performed sequentially.

During a configuration stage of operation, a user may specify the input data set 802 or data sources from which the input data set 802 is determined. The user may also specify a goal for the genetic algorithm 810. For example, if the genetic algorithm 810 is being used to determine a topology of the one or more models 724, the user may provide one or more characteristics of the neural networks. The system 800 may then constrain models processed by the genetic algorithm 810 to those that have the one or more characteristics.

Thus, in particular implementations, the user can configure various aspects of the models that are to be generated/evolved by the genetic algorithm 810. Configuration input may indicate a particular data field of the data set that is to be included in the model or a particular data field of the data set that is to be omitted from the model, may constrain allowed model topologies (e.g., to include no more than a specified number of input nodes output nodes, no more than a specified number of hidden layers, no recurrent loops, etc.).

Further, in particular implementations, the user can configure aspects of the genetic algorithm 810, such as via input to graphical user interfaces (GUIs). For example, the user may provide input to limit a number of epochs that will be executed by the genetic algorithm 810. Alternatively, the user may specify a time limit indicating an amount of time that the genetic algorithm 810 has to execute before outputting a final output model, and the genetic algorithm 810 may determine a number of epochs that will be executed based on the specified time limit. To illustrate, an initial epoch of the genetic algorithm 810 may be timed (e.g., using a hardware or software timer at the computing device executing the genetic algorithm 810), and a total number of epochs that are to be executed within the specified time limit may be determined accordingly. As another example, the user may constrain a number of models evaluated in each epoch, for example by constraining the size of the input set 820 and/or the output set 830.

After configuration operations are performed, the genetic algorithm 810 may begin execution based on the input data set 802. Parameters of the genetic algorithm 810 may include but are not limited to, mutation parameter(s), a maximum number of epochs the genetic algorithm 810 will be executed, a threshold fitness value that results in termination of the genetic algorithm 810 even if the maximum number of generations has not been reached, whether parallelization of model testing or fitness evaluation is enabled, whether to evolve a feedforward or recurrent neural network, etc. As used herein, a “mutation parameter” affects the likelihood of a mutation operation occurring with respect to a candidate neural network, the extent of the mutation operation (e.g., how many bits, bytes, fields, characteristics, etc. change due to the mutation operation), and/or the type of the mutation operation (e.g., whether the mutation changes a node characteristic, a link characteristic, etc.). In some examples, the genetic algorithm 810 may utilize a single mutation parameter or set of mutation parameters for all models. In such examples, the mutation parameter may impact how often, how much, and/or what types of mutations can happen to any model of the genetic algorithm 810. In alternative examples, the genetic algorithm 810 maintains multiple mutation parameters or sets of mutation parameters, such as for individual or groups of models or species. In particular aspects, the mutation parameter(s) affect crossover and/or mutation operations, which are further described herein. In a particular implementation, the mutation parameter is adjusted by the system 800 based on characteristics of the input data set 802, as described with reference to FIG. 7.

The genetic algorithm 810 may automatically generate an initial set of models based on the input data set 802 and configuration input. Each model may be specified by at least a neural network topology, an activation function, and link weights. The neural network topology may indicate an arrangement of nodes (e.g., neurons). For example, the neural network topology may indicate a number of input nodes, a number of hidden layers, a number of nodes per hidden layer, and a number of output nodes. The neural network topology may also indicate the interconnections (e.g., axons or links) between nodes. In some aspects, layers nodes may be used instead of or in addition to single nodes. Examples of layer types include long short-term memory (LSTM) layers, gated recurrent units (GRU) layers, fully connected layers, and convolutional neural network (CNN) layers. In such examples, layer parameters may be involved instead of or in addition to node parameters.

The initial set of models may be input into an initial epoch of the genetic algorithm 810 as the input set 820, and at the end of the initial epoch, the output set 830 generated during the initial epoch may become the input set 820 of the next epoch of the genetic algorithm 810. In some examples, the input set 820 may have a specific number of models.

For the initial epoch of the genetic algorithm 810, the topologies of the models in the input set 820 may be randomly or pseudo-randomly generated within constraints specified by any previously input configuration settings or by one or more architectural parameters. Accordingly, the input set 820 may include models with multiple distinct topologies. For example, a first model may have a first topology, including a first number of input nodes associated with a first set of data parameters, a first number of hidden layers including a first number and arrangement of hidden nodes, one or more output nodes, and a first set of interconnections between the nodes. In this example, a second model of epoch may have a second topology, including a second number of input nodes associated with a second set of data parameters, a second number of hidden layers including a second number and arrangement of hidden nodes, one or more output nodes, and a second set of interconnections between the nodes. The first model and the second model may or may not have the same number of input nodes and/or output nodes.

The genetic algorithm 810 may automatically assign an activation function, an aggregation function, a bias, connection weights, etc. to each model of the input set 820 for the initial epoch. In some aspects, the connection weights are assigned randomly or pseudo-randomly. In some implementations, a single activation function is used for each node of a particular model. For example, a sigmoid function may be used as the activation function of each node of the particular model. The single activation function may be selected based on configuration data. For example, the configuration data may indicate that a hyperbolic tangent activation function is to be used or that a sigmoid activation function is to be used. Alternatively, the activation function may be randomly or pseudo-randomly selected from a set of allowed activation functions, and different nodes of a model may have different types of activation functions. In other implementations, the activation function assigned to each node may be randomly or pseudo-randomly selected (from the set of allowed activation functions) for each node the particular model. Aggregation functions may similarly be randomly or pseudo-randomly assigned for the models in the input set 820 of the initial epoch. Thus, the models of the input set 820 of the initial epoch may have different topologies (which may include different input nodes corresponding to different input data fields if the data set includes many data fields) and different connection weights. Further, the models of the input set 820 of the initial epoch may include nodes having different activation functions, aggregation functions, and/or bias values/functions.

Each model of the input set 820 may be tested based on the input data set 802 to determine model fitness. For example, the input data set 802 may be provided as input data to each model, which processes the input data set (according to the network topology, connection weights, activation function, etc., of the respective model) to generate output data. The output data of each model may be evaluated using the fitness function 840 to determine how well the model modeled the input data set 802 (i.e., how conducive each model is to clustering the input data). In some examples, fitness of a model based at least in part on reliability of the model, performance of the model, complexity (or sparsity) of the model, size of the latent space, or a combination thereof.

In some examples, the genetic algorithm 810 may employ speciation. In a particular aspect, a species ID of each of the models may be set to a value corresponding to the species that the model has been clustered into. Next, a species fitness may be determined for each of the species. The species fitness of a species may be a function of the fitness of one or more of the individual models in the species. As a simple illustrative example, the species fitness of a species may be the average of the fitness of the individual models in the species. As another example, the species fitness of a species may be equal to the fitness of the fittest or least fit individual model in the species. In alternative examples, other mathematical functions may be used to determine species fitness. The genetic algorithm 810 may maintain a data structure that tracks the fitness of each species across multiple epochs. Based on the species fitness, the genetic algorithm 810 may identify the “fittest” species, which may also be referred to as “elite species.” Different numbers of elite species may be identified in different embodiments.

In a particular aspect, the genetic algorithm 810 uses species fitness to determine if a species has become stagnant and is therefore to become extinct. As an illustrative non-limiting example, the stagnation criterion 850 may indicate that a species has become stagnant if the fitness of that species remains within a particular range (e.g., +/−5%) for a particular number (e.g., 5) epochs. If a species satisfies a stagnation criterion, the species and all underlying models may be removed from the genetic algorithm 810.

The fittest models of each “elite species” may be identified. The fittest models overall may also be identified. An “overall elite” need not be an “elite member,” e.g., may come from a non-elite species. Different numbers of “elite members” per species and “overall elites” may be identified in different embodiments.”

The output set 830 of the epoch may be generated. In the illustrated example, the output set 830 includes the same number of models as the input set 820. The output set 830 may include each of the “overall elite” models and each of the “elite member” models. Propagating the “overall elite” and “elite member” models to the next epoch may preserve the “genetic traits” that resulted in such models being assigned high fitness values.

The rest of the output set 830 may be filled out by random reproduction using the crossover operation 860 and/or the mutation operation 870. After the output set 830 is generated, the output set 830 may be provided as the input set 820 for the next epoch of the genetic algorithm 810.

During a crossover operation 860, a portion of one model is combined with a portion of another model, where the size of the respective portions may or may not be equal. When normalized vectors are used to represent neural networks, the crossover operation may include concatenating bits/bytes/fields 0 to p of one normalized vector with bits/bytes/fields p+1 to q of another normalized vector, where p and q are integers and p+q is equal to the size of the normalized vector. When decoded, the resulting normalized vector after the crossover operation produces a neural network that differs from each of its “parent” neural networks in terms of topology, activation function, aggregation function, bias value/function, link weight, or any combination thereof.

Thus, the crossover operation 860 may be a random or pseudo-random operator that generates a model of the output set 830 by combining aspects of a first model of the input set 820 with aspects of one or more other models of the input set 820. For example, the crossover operation 860 may retain a topology of hidden nodes of a first model of the input set 820 but connect input nodes of a second model of the input set to the hidden nodes. As another example, the crossover operation 860 may retain the topology of the first model of the input set 820 but use one or more activation functions of the second model of the input set 820. In some aspects, rather than operating on models of the input set 820, the crossover operation 860 may be performed on a model (or models) generated by mutation of one or more models of the input set 820. For example, the mutation operation 870 may be performed on a first model of the input set 820 to generate an intermediate model and the crossover operation may be performed to combine aspects of the intermediate model with aspects of a second model of the input set 820 to generate a model of the output set 830.

During the mutation operation 870, a portion of a model is randomly modified. The frequency, extent, and/or type of mutations may be based on the mutation parameter(s) described above, which may be user-defined, randomly selected/adjusted, or adjusted based on characteristics of the input set 820. When normalized vector representations are used, the mutation operation 870 may include randomly modifying the value of one or more bits/bytes/portions in a normalized vector.

The mutation operation 870 may thus be a random or pseudo-random operator that generates or contributes to a model of the output set 830 by mutating any aspect of a model of the input set 820. For example, the mutation operation 870 may cause the topology of a particular model of the input set to be modified by addition or omission of one or more input nodes, by addition or omission of one or more connections, by addition or omission of one or more hidden nodes, or a combination thereof. As another example, the mutation operation 870 may cause one or more activation functions, aggregation functions, bias values/functions, and/or or connection weights to be modified. In some aspects, rather than operating on a model of the input set, the mutation operation 870 may be performed on a model generated by the crossover operation 860. For example, the crossover operation 860 may combine aspects of two models of the input set 820 to generate an intermediate model and the mutation operation 870 may be performed on the intermediate model to generate a model of the output set 830.

The genetic algorithm 810 may continue in the manner described above through multiple epochs until a specified termination criterion, such as a time limit, a number of epochs, or a threshold fitness value (e.g., of an overall fittest model), is satisfied. When the termination criterion is satisfied, an overall fittest model of the last executed epoch may be selected and output as reflecting the topology of the one or more models 724 of FIG. 7. The aforementioned genetic algorithm-based procedure may be used to determine the topology of zero, one, or more than one neural network of the one or more models 724.

The systems and methods illustrated herein may be described in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like.

The systems and methods of the present disclosure may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based (e.g., cloud computing) embodiment, an entirely hardware embodiment, or an embodiment combining aspects of the internet, software and hardware. Furthermore, the system may take the form of a computer program product on a computer-readable storage medium or device having computer-readable program code (e.g., instructions) embodied or stored in the storage medium or device. Any suitable computer-readable storage medium or device may be utilized, including hard disks, CD-ROM, optical storage devices, magnetic storage devices, and/or other storage media. Thus, the system 100 may be implemented using one or more computer hardware devices (which may be communicably coupled via local and/or wide-area networks) that include one or more processors, where the processor(s) execute software instructions corresponding to the various components of FIG. 1. Alternatively, one or more of the components of FIG. 1 may be implemented using a hardware device, such as a field-programmable gate array (FPGA) device, an application-specific integrated circuit (ASIC) device, etc. As used herein, a “computer-readable storage medium” or “computer-readable storage device” is not a signal (i.e., a non-transitory computer-readable storage medium).

Systems and methods may be described herein with reference to screen shots, block diagrams and flowchart illustrations of methods, apparatuses (e.g., systems), and computer media according to various aspects. It will be understood that each functional block of a block diagrams and flowchart illustration, and combinations of functional blocks in block diagrams and flowchart illustrations, respectively, can be implemented by computer program instructions.

Computer program instructions may be loaded onto a computer or other programmable data processing apparatus to produce a machine, such that the instructions that execute on the computer or other programmable data processing apparatus create means for implementing the functions specified in the flowchart block or blocks. These computer program instructions may also be stored in a computer-readable memory or device that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

Although the disclosure may include a method, it is contemplated that it may be embodied as computer program instructions on a tangible computer-readable medium, such as a magnetic or optical memory or a magnetic or optical disk/disc. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

Changes and modifications may be made to the disclosed embodiments without departing from the scope of the present disclosure. These and other changes or modifications are intended to be included within the scope of the present disclosure, as expressed in the following claims.

What is claimed is:

1. A system for data analysis of geographic data and associated context data, the system comprising:
one or more processors; and
one or more memory devices storing instructions that are executable by the one or more processors to perform operations including:
receiving a query;
determining, based on the query, one or more data models to output information requested by the query;
accessing, based on the query, geographic data and associated context data from one or more data repositories;
providing the geographic data and the associated context data as input to the one or more data models to generate model output; and
generating output data representing the model output in response to the query.

2. The system of claim 1, wherein the one or more memory devices further store a plurality of data models including the one or more data models, each data model of the plurality of data models associated with a respective type of model output data.

3. The system of claim 2, wherein the determining the one or more data models includes selecting the one or more data model from among the plurality of data models based on the query and the respective type of model output data of each data model.

4. The system of claim 2, wherein the determining the data model includes determining that the plurality of data models do not include a particular data model to output the information requested by the query, and the operations further comprise automatically generating the particular data model using an automatic machine learning model building process.

5. The system of claim 1, wherein the operations further comprise, before receiving the query:
obtaining electronic records from a plurality of distinct data sources;
generating data including at least a portion of the geographic data, the associated context data, or both, based on the electronic records; and
storing the generated data at the one or more data repositories.

6. The system of claim 5, wherein the plurality of distinct data sources includes one or more of a government digital records database or a map provider database.

7. The system of claim 5, wherein the electronic records include real estate data, topographic data, infrastructure data, geologic data, descriptions of named or designated locations, or a combination thereof.

8. The system of claim 5, wherein the electronic records include weather data, social media data, video streams, internet-of-things device data, transportation data, security data, healthcare data, utility data, event data, or a combination thereof.

9. The system of claim 5, wherein the electronic records include two or more sets of time series data and generating the generated data includes time aligning the two or more sets of time series data.

10. The system of claim 5, wherein the electronic records include two or more conflicting records, and wherein the generating the generated data includes reconciling the two or more conflicting records.

11. The system of claim 5, wherein the electronic records include at least one image, and wherein the generating the generated data includes analyzing the image to generate information descriptive of the image.

12. The system of claim 5, wherein the electronic records include at least one natural language text, and wherein the generating the generated data includes analyzing the natural language text to identify events that are scheduled to occur in a geographic area.

13. The system of claim 1, wherein the query is an unstructured, natural language query.

14. A method of data analysis of geographic data and associated context data, the method comprising:
receiving, at one or more processors, a query;
determining, by the one or more processors based on the query, one or more data models to output information requested by the query;
accessing, by the one or more processors based on the query, geographic data and associated context data from one or more data repositories;
providing the geographic data and the associated context data as input to the one or more data models to generate model output; and
generating, by the one or more processors, output data representing the model output in response to the query.

15. The method of claim 14, wherein the determining the data model includes selecting the data model from among a plurality of data models in a memory device that is accessible to the one or more processors.

16. The method of claim 14, wherein the determining the data model comprises:
searching a plurality of data models stored in a memory device to determine whether the plurality of data models include a particular data model to output the information requested by the query; and
in response to determining that the plurality of data models do not include the particular data model, automatically generating the particular data model using an automatic machine learning model building process.

17. The method of claim 14, further comprising, before receiving the query:
obtaining, by the one or more processors, electronic records from a plurality of distinct data sources;
generating, by the one or more processors, data including at least a portion of the geographic data, the associated context data, or both, based on the electronic records; and
storing the generated data at the one or more data repositories.

18. The method of claim 14, wherein the query includes an unstructured, natural language query.

19. A computer-readable storage device storing instructions that are executable by one or more processors to cause the one or more processor to perform operations comprising:
receiving a query;
determining, based on the query, one or more data models to output information requested by the query;
accessing, based on the query, geographic data and associated context data from one or more data repositories;
providing the geographic data and the associated context data as input to the one or more data models to generate model output; and
generating output data representing the model output in response to the query.

20. The computer-readable storage device of claim 19, wherein the operations further comprise automatically generating the data model using an automatic machine learning model building process in response to the one or more processors determining that a plurality of data models stored at the computer readable storage device do not include a particular data model to output the information requested by the query.
